(19) United States
(12) Patent Application Publication
(10) Pub. No.: US 2006/0282379 A1
(43) Pub. Date: Dec. 14, 2006

(54) Strategic communications systems and methods

(75) Inventors: Glen David Wordekemper, Omaha, NE (US); Robert Alan Stier, Papillion, NE (US); Michelle Marie Ellwanger, Omaha, NE (US); Kelly Liberty, Omaha, NE (US); Sandra Sue Haugen, Papillion, NE (US); William Hickox, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/152,040

(22) Filed: Jun. 13, 2005

(51) Int. Cl. G06Q 40/00

(52) U.S. Cl. 705/40

(57) ABSTRACT

Systems, methods, and machine-readable mediums are disclosed for strategic communications. In one embodiment, the strategic communications system comprises a rules data store including a decision rule, a recipient data store including recipient data for a plurality of recipients, and decision logic configured to determine for each of the recipients whether to include a decision-based component on the correspondence for the respective recipient based at least on the decision rule and the data associated with the respective recipient. The strategic communications system further includes correspondence manager logic to format the correspondence for each of the recipients and a printer including a selective perforation module to selectively add the perforation to the correspondences including the decision-based component.

### BACKGROUND OF THE INVENTION

Companies and organizations may market their products and services to consumers using a variety of different marketing channels. These marketing channels may include direct mailings, electronic mailings, telephone calls, television advertisements, and print advertisements. A company may want its marketing materials to have a consistent brand between all of the different marketing channels used. However, this is not always possible, particularly in offers/advertisements included in direct mailings.

Additionally, mailing costs for information mailed to consumers are increasing. To spread the costs, a company sending a primary correspondence (such as a credit card statement or other type of bill), may assemble information from other companies and include the information in with its mailings of the primary correspondence. The company may also cross-market its other products or services with the primary correspondence.

Although consumers are known to spend a much longer time viewing bills, the types of marketing material and format of the marketing material that may be included on a bill is limited. For instance, the correspondence must have the same color components for all the recipients as the color is applied with a static press. As another example, coupons may be inserted into the same envelope but may not be included on the bill. Thus, items that may potentially be of interest to the consumer may be discarded or not seen.

### BRIEF SUMMARY OF THE INVENTION

Systems, methods, and machine-readable mediums are disclosed for strategic communications. In some embodiments, the strategic communications system comprises a rules data store, a recipient data store, decision logic, correspondence manager logic, and a printer. The rules data store includes a decision rule and the recipient data store includes recipient data for a plurality of recipients of a correspondence (e.g., a bill, or other type of correspondence sent to the recipients).

The decision logic is communicatively coupled with the rules data store and the recipient data store and is configured to determine for each of the recipients, whether to include a decision-based component on the correspondence for the respective recipient. Merely by way of example, the decision-based component may be a coupon, a check, or an offer. The determination is based at least in part on the decision rule and the data for the respective recipient. Correspondence manager logic formats the correspondence for each of the recipients. The printer includes a selective perforation module to selectively add a perforation to the correspondences including the decision-based component.

The rules data store may also include additional rules for additional decision-based components. In some aspects, the printer may further comprise a MICR component to selectively add MICR information to correspondences including decision-based checks. In other aspects, the printer may further comprise at least one color module to selectively apply color to correspondences including decision-based color components.

The decision rule(s) may include a variety of different types of condition(s) for including the decision-based component. For example, the decision rule may include a condition for a recipient credit limit, a recipient account balance, and/or a recipient account. As another example, the decision rule may include a condition for a purchase of a particular product and the recipient data may indicate the recipients that purchased the product. Other types of conditions for the decision-based component may alternately or additionally be included in the decision rule. The condition(s) for the decision rule may be evaluated by obtaining the recipient data associated with the respective recipient to determine if the decision-based component should be included on the correspondence for the recipient.

In additional embodiments, the correspondence manager logic may be further configured to create and format electronic correspondences for a second subset of recipients. In these embodiments, the strategic communications system may further comprise an electronic messaging system to deliver the electronic correspondences. In some aspects, the electronic messaging system may include tracking data indicating whether one or more of the recipients in the second set read the respective electronic correspondence. The correspondence manager logic may be further configured to format an associated correspondence in physical format after a predetermined time for at least one of the unread electronic correspondences. Alternatively, or additionally, the correspondence logic may be further configured to determine at least one of the electronic correspondences satisfies a mail criteria and based at least in part on the determination, to format a physical correspondence for the recipient of the determined electronic correspondence.

In other embodiments, a method is disclosed which comprises obtaining, with a strategic communications system, a decision rule for a correspondence. Data associated with a recipient of the correspondence is also obtained. By way of example, the correspondence may be a bill. A determination is made whether to include a decision-based component (e.g., coupon, check, etc.) on the correspondence based at least in part on the decision rule and the data. The correspondence is formatted to include a selective perforation if the decision-based component is included and the correspondence is transmitted to a printer configured to selectively add perforations to correspondences. The method may also comprise adding the selective perforation with the printer if the decision-based component is included.

A correspondence for a second recipient may be formatted differently than the correspondence for the first recipient. For example, the correspondence for the first recipient may include the decision-based component, while the correspondence for the second recipient may not include the decision-based component. Additionally, different pages associated with the correspondence may be formatted differently. For instances, a first page of the correspondence may include the selective perforation, while the second page may not include the selective perforation.

In other embodiments, a method is disclosed which comprises obtaining, with a strategic communications system, a decision rule and data associated with a recipient of a correspondence. A determination is made whether to include a decision-based component on the correspondence based at least in part on the decision rule and the data. The correspondence is formatted to include a selective color component if the decision-based component is included and the correspondence is transmitted to a printer, which is configured to selectively add color components to correspondences.

In still additional embodiments, a method is disclosed which comprises creating, with a strategic communications system, an electronic correspondence for a recipient. A determination is made whether to include a decision-based component on the electronic correspondence based at least in part on a decision rule and data associated with the recipient. Merely by way of example, the decision-based component may comprise a special offer and/or a coupon. The electronic correspondence is formatted in accordance with the determination and the electronic correspondence is transmitted to the recipient.

The method may further comprise determining the electronic communication satisfies a mail criteria. An associated correspondence for the recipient is then created in physical format. Creating the associated correspondence may comprise adding at least one decision-based component not included in the electronic correspondence.

In other aspects, the method may further comprise determining, with the strategic communications system, the recipient did not read the electronic correspondence. An associated correspondence for the recipient may then be created in physical format.

A further understanding of the nature and advantages of the present invention may be realized by reference to the remaining portions of the specification and the drawings.

### BRIEF DESCRIPTION OF THE DRAWINGS

Illustrative embodiments in accordance with the invention are illustrated in the drawings in which:

FIG. 1 illustrates an exemplary embodiment of a strategic communications system;

FIG. 2 illustrates an exemplary interface that may be used to create rules for decision-based components;

FIG. 3 is a block diagram illustrating an exemplary printer that may be included in a strategic communications system;

FIG. 4 illustrates a first exemplary correspondence that may be created by a strategic communications system;

FIG. 5 illustrates a second exemplary correspondence that may be created by a strategic communications system;

FIG. 6 illustrates an exemplary electronic correspondence that may be created by a strategic communications system;

FIG. 7 illustrates an exemplary electronic notification that may be sent by a strategic communications system;

FIG. 8 is a block diagram of an exemplary computer system upon which components of a strategic communications system may be implemented;

FIG. 9 is a flow diagram illustrating an exemplary method that may be used to generate correspondences for recipients; and

FIG. 10 is a flow diagram of an exemplary method that may be used by a strategic communications system to manage sending electronic correspondences.

### DETAILED DESCRIPTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

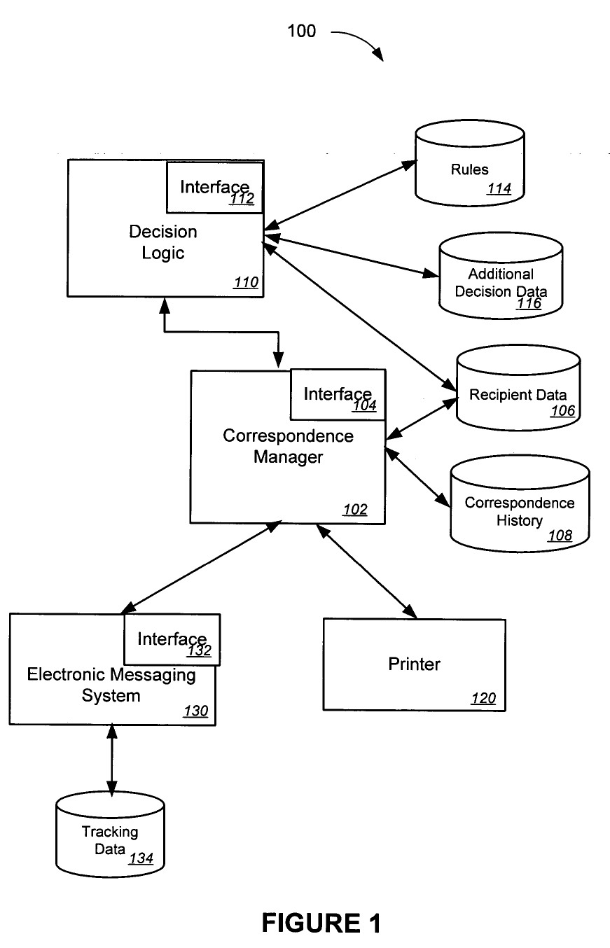

FIG. 1 illustrates an exemplary embodiment of a strategic communications system 100. The strategic communications system 100 may be used to send a variety of different types of correspondences to recipients. Merely by way of example, correspondences may be bills (e.g., credit card statements, insurance, mortgage, utility bills, etc.), tax statement, license renewals, or other type of correspondence that include information for a recipient. As will be described in further detail below, decision-based components may be included on the correspondences. Recipients of a related correspondence may each have different decision-based components included on their respective correspondence.

The strategic communications system 100 may include a correspondence manager 102 communicatively coupled with decision logic 110, printer 120, and electronic messaging system 130. A communicative coupling is a coupling that allows communication between the components. This coupling may be by means of a bus, cable, network, wireless mechanism, program code call (e.g., modular or procedural call) or other mechanism. Thus, it should be appreciated that components which are communicatively coupled may reside on the same or different physical device.

Correspondence manager 102 may be used to manage strategic communications. In some aspects, correspondence manager 102 may be used to manage communications across multiple channels. Thus, correspondence manager 102 may generate and format correspondences for delivery by mail and/or delivery by electronic means.

One or more entities may use correspondence manager 102 to manage the creation and production of correspondences sent from the entity to a plurality of recipients. The correspondences may be bills (e.g., credit card statements, utility bills, health care bills, etc.), tax statements, license renewals, or other type of correspondence having information for recipients. The production of correspondences may be triggered at a predetermined time (e.g., cycle end date) and/or upon occurrence of a predetermined event. In some aspects, the trigger may be an external tickler sent to correspondence manager 102. In other aspects, correspondence manager may itself trigger the start of correspondence production.

Correspondence manager 102 may create the layout of the correspondence and format the correspondence for each recipient. Correspondence manager 102 may also, in some embodiments, determine the delivery channel for the correspondence. In some cases, related correspondences may be formatted differently and/or may include different components depending upon the type of delivery channel used.

Correspondence manager 102 may communicate with decision logic 110 to determine one or more decision-based components to include on a particular recipient's correspondence. Decision-based components may be coupons, checks, special offers, advertisements, or other information to be included on a recipient's correspondence based on data associated with the recipient. The recipients may, in effect, be segmented into different market groups, with each segment of recipients receiving different decision-based components on their correspondences.

Correspondence manager 102 may be communicatively coupled with recipient data store 106 and may interact with recipient data store 106 during the creation and formatting of correspondences. Recipient data may include primary information to be included on a correspondence (e.g., account balance, transaction history, payment due, tax information, license information, etc.). Recipient data may also include other attributes about a recipient that may be used to determine whether to include decision-based components on a recipient's correspondence. Merely by way of example, recipient data may include household income, address information, geographical location, age, sex, marital status, number of children, special interests, transaction history (e.g., purchase of particular items, total amount of purchases over a predetermined time period, merchants from which goods or services were purchases, or any other type of transaction history), credit rating, associated account information (e.g., mortgage account information, credit card account information, savings account information, checking account information, etc.), and/or any other type of information about a recipient. It should be appreciated that recipient data 106 may be provided from one or more sources (e.g., credit card issuers, utility providers, market analyzers, etc.).

Correspondence manager 102 may also be communicatively coupled with correspondence history data store 108. Correspondence history data store 108 may store information about correspondences sent to recipients. The correspondence history information may include information about which decision-based components were included on a particular recipient's correspondence, the total number of correspondences including a decision-based component, a tracking identifier associated with the correspondence, a date mailed, and/or any other information about a correspondence managed by correspondence manager 102.

In some embodiments, correspondence manager 102 may transmit correspondence history information to the sender of the correspondences and/or any entities having components included on the correspondences. The correspondence history information may be used by the entities to measure marketing campaign success. By way of example, the entity may be able to determine the number of recipients that received a particular offer. This information may then be used to determine a response rate for the particular offer.

Correspondence manager 102 may, in some embodiments, include an interface 104 that may be used by entities to provide correspondence instructions for correspondences managed by correspondence manager 102. These instructions may include layout instructions, formatting instructions, recipient information, and/or any other type of information used by correspondence manager 102 to manage correspondences for the entity or entities. In other aspects, interface 104 may be used by an entity to view or obtain correspondence history 108 data.

As previously described, correspondence manager 102 may be communicatively coupled with decision logic 110. Decision logic 110 may be configured to determine whether to include decision-based component(s) on a correspondence for a recipient. The decision on whether to include a component may be made by applying one or more rule(s) 114 associated with decision-based component to attributes about the recipient obtained from recipient data store 106. Additional decision data 116 may be also be used to determine whether to include decision-based components. Merely by way of example, additional decision data 116 may include priority information for decision-based components, list of acceptable entities that may include decision-based components on a particular correspondence type, list of unacceptable entities that may not include decision-based components on a particular correspondence type, bidding information, and/or other information used by decision logic 110 to determine whether to include a decision-based component on a correspondence for a particular recipient.

A rule 114 for a decision-based component may include one or more conditions which must be satisfied for the decision-based component to be included. The conditions may be associated with recipient data such as credit limits, account balances, account types, transaction history information (e.g., purchase of a particular product, which may be identified by a SKU or other product identifier) or any other data about a recipient (such as the exemplary recipient data previously described). In some aspects, the data may be compared to predetermined values or ranges to determine whether the recipient satisfies the criteria. Other conditions may include a comparison of one data element (e.g., current balance) to a second data element (e.g., credit limit). Thus, the decision rules 114 may, in effect, segment recipients into one or more marketing groups

In some embodiments, elements of the decision-based components may also be dependent upon recipient data 106 or other decision information 116. For instances, a coupon amount or discount percentage may vary based on the recipient's transaction history (e.g., total amount spent in purchases over a predetermined time period). As another example, recipient data 106 and/or other decision information 116 may be used to determine the expiration data for an offer or coupon. Many other types of conditions may also be used to determine whether to include a decision-based component and/or determine elements on the decision-based component.

It should be appreciated that a variety of different types of decision-based components may be included on correspondences. Merely by way of example, decision-based components may be coupons, checks, special offers, advertisements, loyalty program reward information, and/or any type of incentive, offer, or information provided to one or more recipients having associated attributes satisfying the condition(s) for providing the decision-based component. Decision-based components may comprise words, logos, graphic objects, icons and/or images. As will be described further below, some of the decision-based components may be formatted to include color. For example, color components may be graphs, color advertisements, coupons with color, offers having color, or any other type of component that includes color. The color may be used to help capture the attention of the recipient and/or to achieve brand consistency with other marketing channels.

Decision logic 110 may include an interface 112 that may be used to communicate with entities that send correspondences and/or entities providing decision-based components. By way of example, interface 112 may include a web-based interface, graphical user interface application, or other type of communication interface. Interface 112 may be used by entities to create and edit rules for decision-based components. Interface 112 may also be used to receive bids or auction information for space on a correspondence. Alternatively, a second interface may be provided to receive bids/auction information.

Correspondence manager 102 may also perform white space management, page management and/or weight management for correspondences. A sender of the correspondence may, in some aspects, provide parameters used to perform space/weight management. For example, a sender may specify a minimum amount of space to dedicate to charity components. As other examples, a sender may specify a maximum number of pages and/or weight for correspondences or may prioritize decision-based components. In some embodiments, decision logic 110 may determine a set of decision-based components that may optionally be included in a particular correspondence and correspondence manager 102 may make the determination as to which of optional components in the set should be included in a correspondence based at least in part on white space management, page management, and/or weight management decisions. In other embodiments, correspondence manager 102 may communicate parameters (e.g., available white space, page space, weight) to decision logic 110 and decision logic 110 may factor in the parameters when determining which decision-based components to include on a recipient's correspondence. A bidding or auctioning process between competing entities wishing to include decision-based component(s) may also be used to determine which components to include. Further details of systems and methods that may be used to allocate excess white space and/or determine which decision-based components to include on a recipient's correspondence may be found in U.S. Application Publication No. 2004/0204789, entitled “Systems and Methods for Allocating Excess Space Associated with Mailings”, published Oct. 14, 2004, the details of which are hereby incorporated by reference.

Decision logic 110 may also take into account the type of distribution channel that will be used to deliver the recipient's correspondence. For example, a check may be included on a correspondence mailed to a recipient but may not be included in an electronic correspondence. As another example, a link to web site may be included on an electronic correspondence, but not on a mailed correspondence. Thus, the decision rules may include conditions related to delivery channel. Corollary factors similar to white space management factors may also be used when determining decision-based components for electronic correspondences. Merely by way of example, factors that may be considered for electronic correspondences may include screen space, maximum desirable length, and/or maximum desirable size.

In other aspects, decision logic 110 may determine a decision-based component should be included on a recipient's correspondence and correspondence manager 102 may format or select the information to use for the decision-based component based on the delivery channel used for the recipient. Merely by way of example, correspondence manager 102 may determine to include a decision-based component as a coupon if the correspondence will be mailed to the recipient and as a graphic advertisement (possibly including a hyperlink) if the correspondence will be electronically delivered to the recipient. In other aspects, correspondence manager 102 may determine not to include a particular decision-based component if the component is not supported by the delivery channel (e.g., checks may not be included in electronic correspondences).

Once decision logic 110 has determined a decision-based component should be included on a recipient's correspondence, correspondence manager 102 may obtain the decision-based component and add the decision-based component to the recipient's correspondence. Correspondence manager 102 may also add associated formatting options along with the decision-based component. Merely by way of example, the formatting options may include selective perforations (e.g., for coupons or checks) or MICR information (for checks). The decision-based components or other components on a recipient's correspondence may also be formatted to include color.

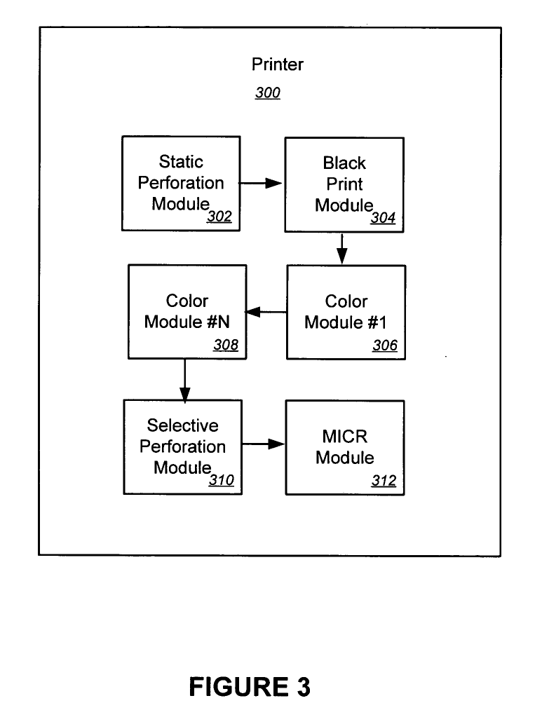

Printer 120 may be configured to selectively add perforations, MICR information, and/or color components to an individual recipient's correspondence in accordance with the format of the recipient's correspondence. Thus, in contrast to prior art solutions, a recipient's correspondence may include varying color components, perforations, and/or MICR information that differ from correspondences for other recipients associated with a correspondence production. Additionally, an individual page of a recipient's correspondence may also include colors, perforations, and/or MICR information different than other pages of the correspondence. Further details of printer 120 will be described in more detail below with reference to FIG. 3.

Strategic communications system 100 may also include electronic messaging system 130. Electronic messaging system 130 may be configured to manage and deliver correspondences in electronic format. Merely by way of example, correspondences may be delivered by email. Alternatively, or additionally, electronic correspondences may be made available on a web page, may be faxed, may be sent to a mobile device, and/or may be delivered or made available using any other suitable electronic means.

In some aspects, electronic messaging system 130 may track the status of an electronic correspondence. For instance, the electronic messaging system 130 may determine if a recipient has opened an electronic correspondence and/or has selected a component included on the electronic correspondence (e.g., selected a hyperlink and “clicked through” to a web site associated with a decision-based component). Other information associated with an electronic correspondence may also be tracked by electronic messaging system 130.

The tracking information (or other associated information) may be stored in tracking data store 134. Tracking information may be made available to entities sending correspondences and/or other entities associated with decision-based components via interface 132. The raw information may be made available and/or reports may be created by electronic messaging system to display tracking data.

In some aspects, tracking information 134 may also be used by electronic messaging system 130, correspondence manager 102, and/or other component to trigger correspondence production. For example, electronic messaging system 130 (or other component) may trigger an event to correspondence manager 102 to produce a physical correspondence if an electronic correspondence has not been opened within a predetermined time period. Tracking information 132 may also be used to generate other types of correspondences, such as notifications to recipients. In some aspects, the strategic communications system 100 may also include other tracking information (which may be stored along with tracking information 132 or in a separate data store) to track the delivery of physical correspondences. Thus, events, such as delivery of a physical correspondence, may also trigger electronic correspondence production.

Electronic messaging system 130 may, in some embodiments, deliver electronic notifications (e.g., text messages, instant messages, emails, etc.) to recipients based on various events associated with the recipient. Notifications and/or other types of electronic correspondences may include mechanism(s) that provide the ability for a recipient to accept an offer, such as a reward offer or service subscription. In some aspects, the recipients may configure rules to determine the type of electronic notifications that they wish to receive. For example, electronic messaging system 130 may deliver notifications about account payments, account usage, or other information about a recipient's financial account. In some embodiments, the notifications may be generated by correspondence manager 102 and delivered via electronic messaging system 130. Thus, the notifications may also include decision-based components as previously described.

A variety of different interfaces 104, 112, 132 to strategic communications system were described above. It should be appreciated that interfaces 104, 112, 132 may comprise an interface to a public network (e.g., the Internet), an interface to a proprietary network, and/or other type of communications interface. In some aspects, one or more of the interfaces 104, 112, 132 may be combined into a single interface. In other aspects, additional interfaces or fewer interfaces 104, 112, 132 may be provided.

A number of different data stores 106, 108, 114, 116, 134 were also described above. A data store 106 may be one or more relational databases or components of relational databases (e.g., tables), object databases or components of object databases, spreadsheet(s), text file(s), internal software list(s), or any other type of data structure(s) suitable for storing data. Thus, it should be appreciated that data stores 106, 108, 114, 116, 134 may be each be multiple data storages (of the same or different type) and/or may share a common data storage with other data stores 106, 108, 114, 116, 134.

A number of components were described that may be implemented as logic components. Merely by way of example, these components may include correspondence manager 102, decision logic 110, and/or electronic messaging system 130. Logic components may be one or more software programs, one or more components of a software program (e.g., function or program object), firmware, or other type of machine-executable instructions.

It should be appreciated that the components of strategic communications system 100 may perform additional, less, or alternative functionality than described. It should also be appreciated that strategic communications system 100 may include additional, alternative, or fewer components than illustrated in FIG. 1. For example, strategic communications system 100 may only be used to manage communications for one type of delivery channel and thus printer 120 or electronic messaging system 130 may not be included. As another example, strategic communication system 100 may include a component to perform consolidation of multiple planned mailings. Further details of functionality that may be performed by a consolidation component are described in U.S. patent application Ser. No. 10/353,778, entitled “Methods and Systems for Consolidating Financial Reporting Information”, filed Jan. 27, 2003, the details of which are hereby incorporated by reference. Other variations are also contemplated.

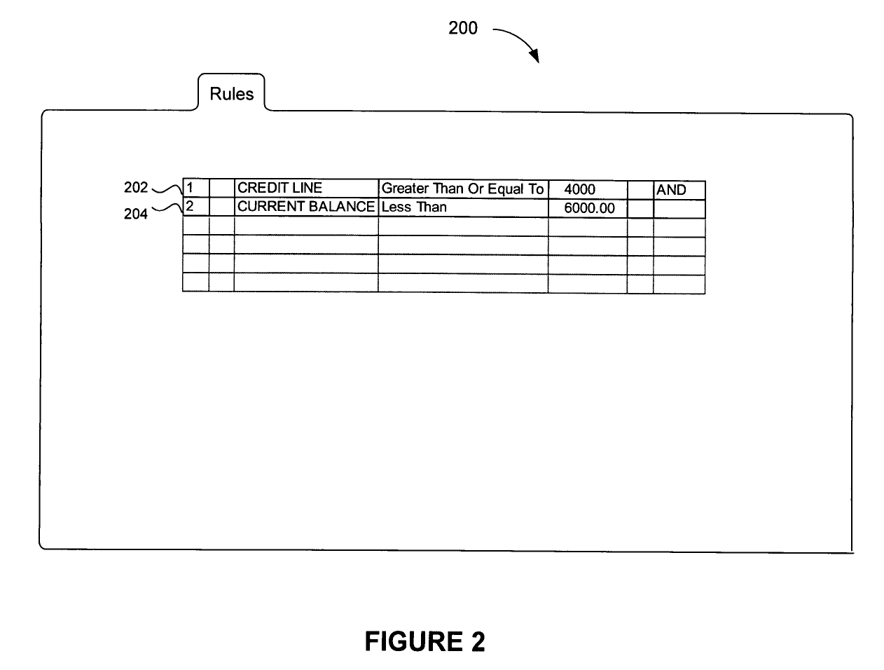

FIG. 2 illustrates an exemplary interface 200 that may be used to create rules for decision-based components. The interface may be provided to assist an entity define one or more decision rules for decision-based components. In some cases, the interface may allow a user to select a variety of different types of decision criteria and/or attributes on which the criteria operates. The selected criteria and attributes may be used to define one or more conditions for a decision-based component.

One example of a type of condition 202 that may be defined using interface 200 is a condition 202 which specifies that the recipient's credit line is greater than or equal to a specified amount (in this case $4,000). Condition 202 is joined to a second condition 204 with an “And” operator. Condition 204 specifies that a current balance of the recipient's account is less than a predetermined amount (in the example $6,000). The combination of conditions 202, 204 may create a rule for including a decision-based component on a recipient's correspondence. It should be appreciated that many other types of conditions may also be created using interface 200. In some aspects, data elements may be compared to other data elements (e.g., credit line compared to credit balance) to create a condition. It should also be appreciated that attributes of multiple accounts may also be used. Thus, an area may be provided (not shown) to specify the particular account(s) to use in the conditions. Other areas may also be included in interface 200 to assist in the creation of decision rules. It should also be appreciated that many other types of conditions may be defined using interface 200 or similar interface.

FIG. 3 illustrates an exemplary printer that may be included in a strategic communications system. The printer includes a static perforation module 302, a black print module 304, one or more color modules 306, 308, a selective perforation module 310, and a MICR module 312. These modules 302-312 may be arranged in any suitable fashion.

Static perforation module 302 may be used to add perforations common to all recipients (e.g., a remittance perforation). Black print module 304 may add black text or black components to a correspondence.

Color modules 306, 308 may be used to selectively apply color to a recipient's correspondence based on the format of the recipient's correspondence. Unlike prior art solutions, which apply color with a static press, the color included on a correspondences for a correspondence job may vary from recipient to recipient. Thus, decision-based components may use color to capture the attention of the user, to achieve brand consistency with other marketing channels, and/or provide information in a more attractive format.

Selective perforation module 310 may be used to selectively add perforations to a recipient's correspondence. In contrast to prior art solutions, the perforations on a recipient's correspondence may be different than other recipients. This may allow strategic communications system to format the correspondence so that some decision-based components (e.g., coupons, checks) are bordered by perforations to provide for easy separation from the correspondence.

MICR module 312 may selectively add MICR information to correspondences. The use of a printer 300 with a selective MICR module 312 may allow checks, or other types of components using MICR information, to be added to a subset of the correspondences associated with recipients meeting the criteria for including the check. Since the MICR information may be selectively added, the decision-based checks may be included at any location on the correspondence.

In other embodiments, printer 300 may include additional or fewer components than shown in FIG. 3. For example, printer 300 may not include MICR module 312 and/or selective perforation module 310. Alternatively, printer 300 may not include color modules 306, 308. Other variations are also contemplated.

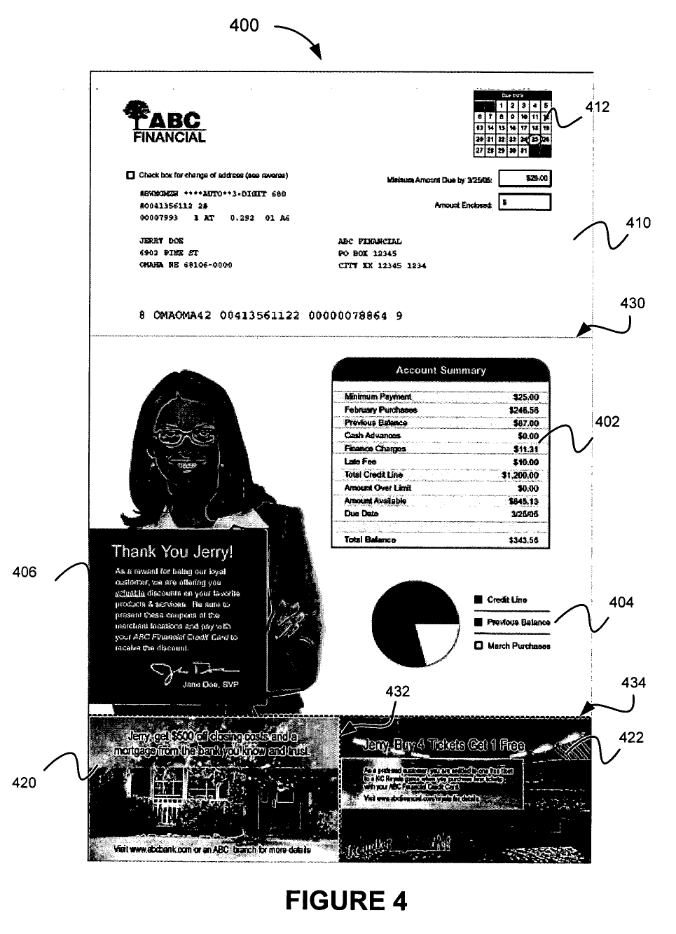

FIGS. 4-7 illustrate exemplary correspondences and notifications that may be created by a strategic communications system. It should be appreciated that strategic communications system may also be used to create different types of correspondences than illustrated by these figures.

One exemplary correspondence that may be created by a strategic communications system is a credit card statement 400. The credit card statement 400 may include a remittance section 410. A perforation 430 is provided to allow the remittance section 410 to be easily separated from the rest of the correspondence. The remittance section also includes a color component of a calendar showing the due date. The due date 412 may be highlighted by circling the due date with a color, such as red, or highlighting the due date with a color so that the due date stands out.

The correspondence 400 may also include account summary information 402. Optionally, the account summary section 402 may include one or more color elements. Other color components, such as graph 404 (used to illustrate available credit, previous balance, and purchases), may also be included on the statement 400.

The recipient of correspondence 400 satisfied one or more conditions associated with decision-based components 406, 420, and 422. Decision-based component 406 is an advertisement. Advertisement 406 may include color elements to make the advertisement eye-catching and/or conform to a brand used by the advertiser. Decision-based components 420, 422 may be coupons. Coupons 420, 422 may also include color elements. Additionally, the statement 400 includes selective perforations 432, 434 to facilitate separation of the coupons 420, 422 from the rest of the correspondence 400.

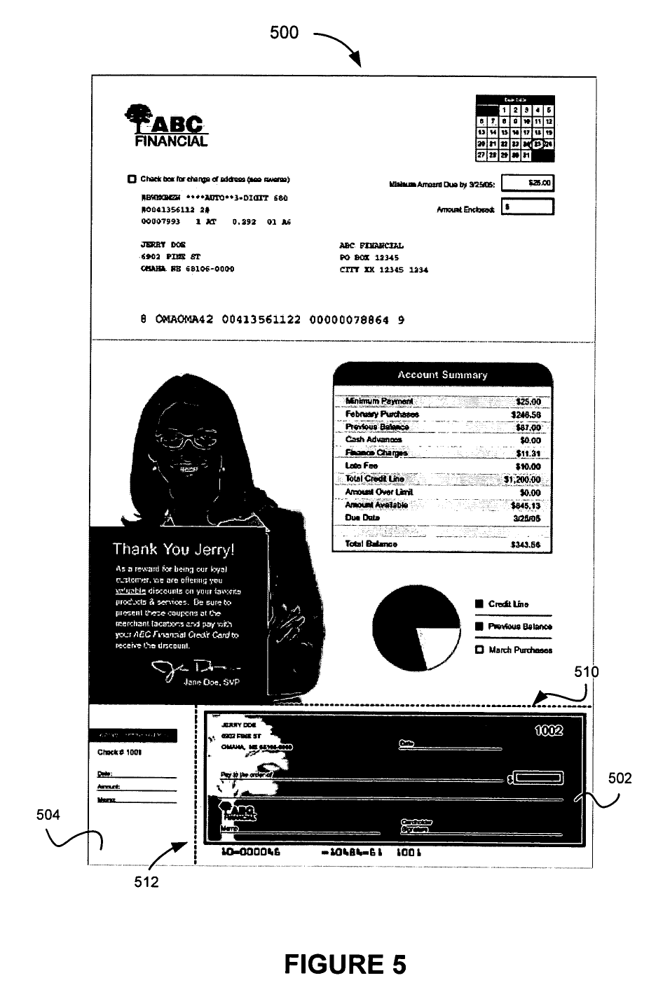

FIG. 5 illustrates a second exemplary credit card statement 500 that may be created by a strategic communications system. Credit card statement 500 includes elements similar to those described with reference to FIG. 4, but does not include coupons 420, 422, or selective perforations 432, 434. Instead, credit card statement 500 includes a decision-based check 502 having MICR information. A check stub 504 is also included on the statement. Selective perforations 510, 512 are provided on the statement 500 to facilitate separation of the check 502 and check stub 504 from the rest of the statement.

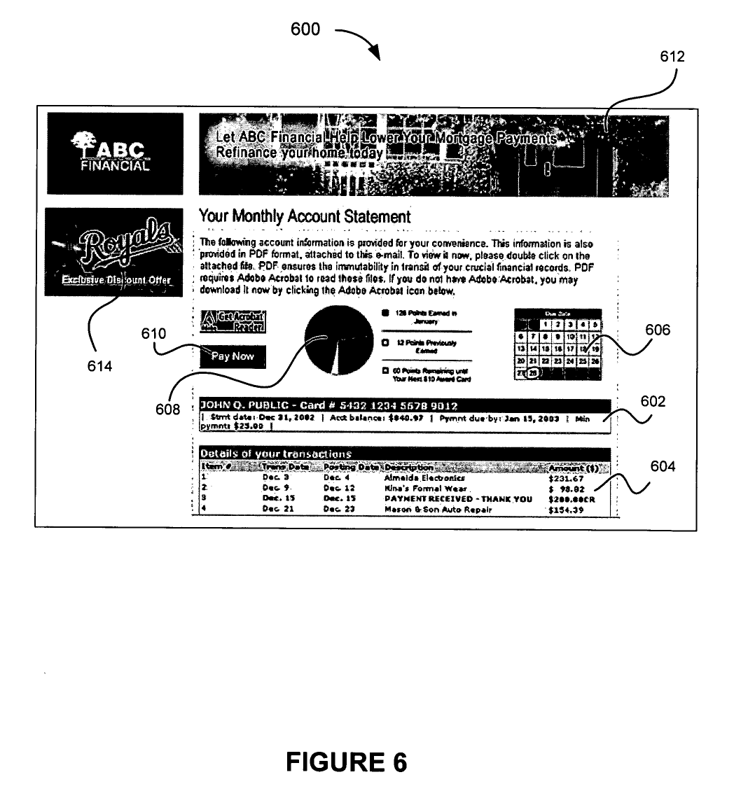

FIG. 6 illustrates an exemplary electronic correspondence 600 that may be created by a strategic communications system. The illustrated electronic correspondence 600 is a credit card statement. The credit card statement 600 may be electronically delivered to a recipient via email and/or may be made available to the recipient on a website.

The credit card statement 600 includes payment due information 602 and transaction details 604. The statement 600 also includes a calendar object 606 displaying the due date for the account and a graph object 608 displaying loyalty information. A mechanism 610 is also provided to allow the recipient to pay the bill online.

Electronic statement 600 includes decision-based components 612, 614. Decision-based component 612 is an advertisement to cross-sell a service offered by the credit card issuer (mortgages). The advertisement 612 may have been included on the statement because attributes associated with the recipient of statement 600 satisfied condition(s) to include the decision-based advertisement 612. Decision-based component 614 is a special offer for baseball tickets that may have been provided to the recipient based on the recipient's address or geographical location. The recipient may be able to view further details about an offer by clicking the component 612, 614. In some instances, the decision-based components 612, 614 may correlate to coupons provided on correspondences that were mailed to the recipient or would have been mailed to the recipient if the recipient received mailed correspondences.

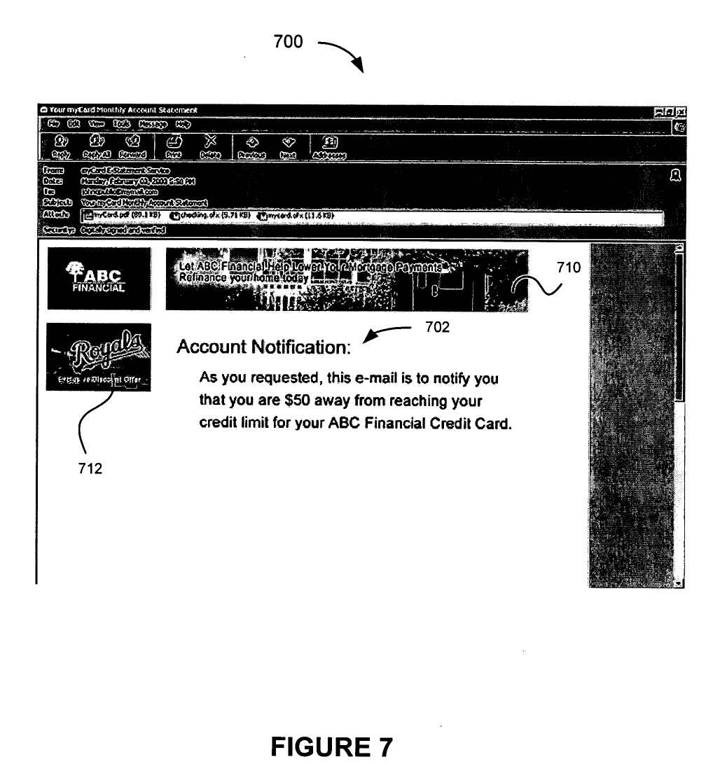

FIG. 7 illustrates an exemplary electronic notification 700 that may be sent by a strategic communications system. The electronic notification 700 includes a message 702 that notifies the recipient that they are within a predetermined dollar amount of their credit limit. The recipient may have requested the notification 700 be sent when the threshold dollar amount was reached. The notification also includes decision-based components 710, 712 similar to those discussed with reference to FIG. 6.

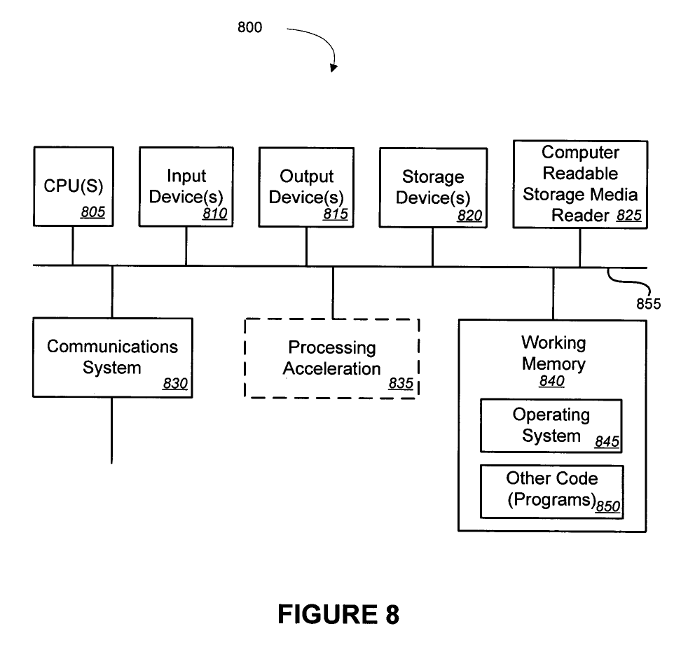

FIG. 8 illustrates one embodiment of a computer system 800 upon which components of a strategic communications system may be implemented. The computer system 800 is shown comprising hardware elements that may be electrically coupled via a bus 855. The hardware elements may include one or more central processing units (CPUs) 805; one or more input devices 810 (e.g., a scan device, a mouse, a keyboard, etc.); and one or more output devices 815 (e.g., a display device, a printer, etc.). The computer system 800 may also include one or more storage device 820. By way of example, storage device(s) 820 may be disk drives, optical storage devices, solid-state storage device such as a random access memory (“RAM”) and/or a read-only memory (“ROM”), which can be programmable, flash-updateable and/or the like.

The computer system 800 may additionally include a computer-readable storage media reader 825; a communications system 830 (e.g., a modem, a network card (wireless or wired), an infra-red communication device, etc.); and working memory 840, which may include RAM and ROM devices as described above. In some embodiments, the computer system 800 may also include a processing acceleration unit 835, which can include a DSP, a special-purpose processor and/or the like.

The computer-readable storage media reader 825 can further be connected to a computer-readable storage medium, together (and, optionally, in combination with storage device(s) 820) comprehensively representing remote, local, fixed, and/or removable storage devices plus storage media for temporarily and/or more permanently containing computer-readable information. The communications system 830 may permit data to be exchanged with a network and/or any other computer or other type of device.

The computer system 800 may also comprise software elements, shown as being currently located within a working memory 840, including an operating system 845 and/or other code 850, such as an application program. The application programs may implement components of a strategic communications system, and/or the methods of the invention. It should be appreciated that alternate embodiments of a computer system 800 may have numerous variations from that described above. For example, customized hardware might also be used and/or particular elements might be implemented in hardware, software (including portable software, such as applets), or both. Further, connection to other computing devices such as network input/output devices may be employed.

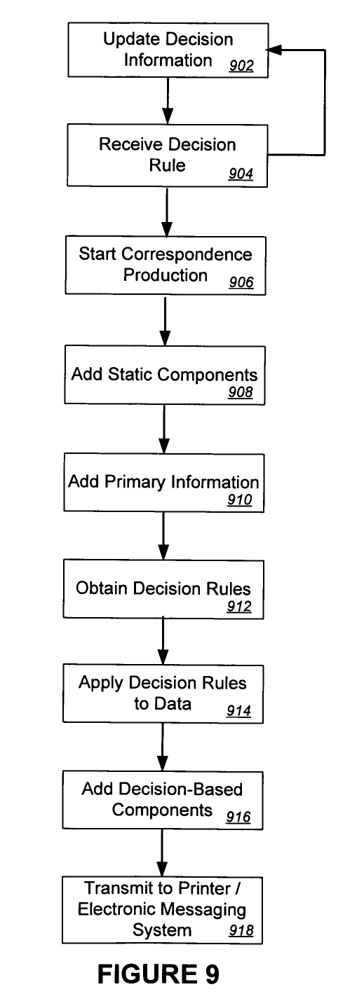

FIG. 9 is a flow diagram illustrating an exemplary method that may be used to generate correspondences for recipients. At one or more times, information used to make decisions for decision-based components may be updated 902. This information may include recipient data (such as any of the recipient data attributes previously described), bid information, auction information, or any other type of information used to decide whether to include a decision-based component on a recipient's correspondence.

The decision information may be updated 902 in a number of ways. For example, the decision information may be updated by an advertiser that is involved in market analysis and/or a market analyzer. Alternatively or additionally, the information may be updated by a credit card company, a utility company, or any other company having information about a recipient. In some aspects, the updates may be received as part of a batch job.

In addition to gathering, maintaining, and/or updating 902 decision information, decision rule information may also be received 904. As previously described, decision rules can indicate conditions for a subset of one or more recipients to receive a decision-based component. In some aspects, decision rules may be received 904 from a user using a decision rule tool, which assists the user in defining the decision rule(s). In other aspects, decision rules may be received 904 in a different manner.

The process of gathering and updating decision information 902 and/or receiving decision rules 904 may be repeated until correspondence production is started 906. The start of a correspondence job may be triggered at a predetermined time, the occurrence of a predetermined event, and/or upon request.

The generation of a correspondence may include adding static components 908 to the correspondence. The static components may include components such as the sender's logo, a remittance perforation, and/or other generic components included on the correspondences for all of the recipients.

The primary information is also added 910 to the correspondence. The primary information added 910 may vary depending upon the type of correspondence being sent. Merely, by way of example, the primary information may include bill information. In some cases, some or all of the primary information may be added as part of the static components 908 as the information may be the same for all of the recipients.

In addition to the static component 908 and the primary information 910, one or more decision-based components may also be added 916 to the correspondence. As previously described, the process of adding decision-based components may include obtaining 912 decision rules for the correspondence and applying 914 the decision rules to decision data (e.g., recipient data). A determination may be made as to whether to include a decision-based component on a particular recipient's correspondence based at least in part on the outcome of applying the decision rules for the correspondence to the data. In some instances, available white space or other similar space considerations, bidding or auction information, or other considerations may also be factored into the decision whether to include a decision-based component. It should be appreciated that the process of adding primary information 910, obtaining decision rules 912, applying decision rules to data 914, and adding 916 decision-based components may be repeated for each recipient.

The correspondence for each recipient may be formatted in accordance with the components included on the correspondence. Thus, as previously described, the correspondences may each include one or more selective perforations, selective MICR information, and/or selective color components. The formatted correspondences may be transmitted 918 to a printer to print the correspondences and add the selective components. Alternatively or additionally, the formatted correspondences may be transmitted 918 to an electronic messaging system for electronic delivery to the recipient.

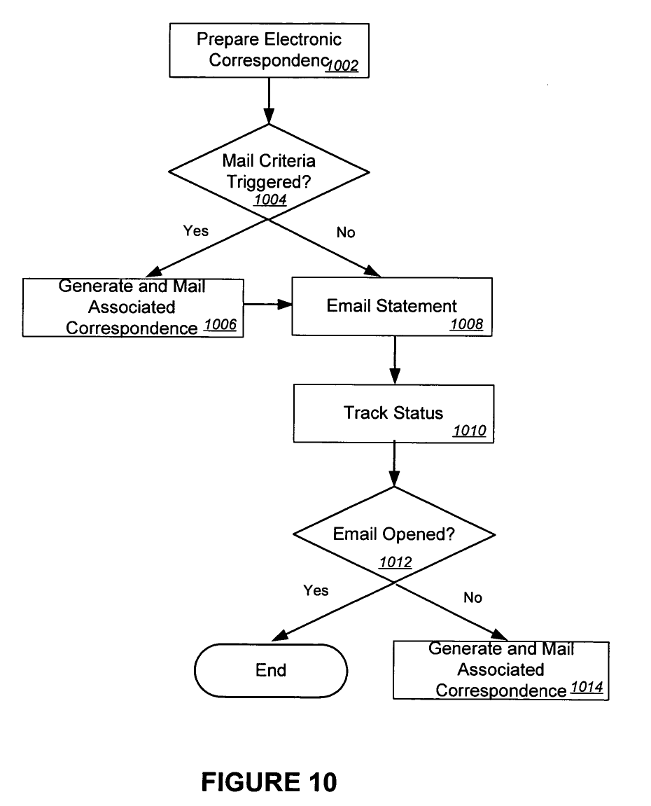

FIG. 10 is a flow diagram of an exemplary method that may be used by a strategic communications system to manage sending electronic correspondences. An electronic correspondence may be prepared 1002 using a process similar to that described in reference to FIG. 9. During the preparation or after the preparation of the electronic correspondence, a determination may be made as to whether a mail criteria was triggered 1004. Mail criteria may be any number of different types of criteria that indicate the correspondence or associated correspondence should be created in physical format to be mailed to the recipient. Merely by way of example, a mail criteria may be triggered if the recipient qualifies for a decision-based check or if the correspondence includes a reward distribution.

If the mail criteria is triggered 1004, an associated correspondence in physical format may be generated and mailed 1006 to the recipient. In some aspects, the associated correspondence may comprise the same primary information as the electronic correspondence. The associated correspondence may also include additional, alternative, or fewer decision-based components and/or decision-based components formatted for physical, instead of electronic, delivery. As an example, a check or check may be included on the associated correspondence that was not included on the electronic correspondence. In other aspects, the associated correspondence may not include the primary information, but may instead be a letter or other type of correspondence with information or components that triggered the mail criteria 1004. Optionally, the electronic correspondence may also be transmitted 1008 to the recipient.

If the mail criteria was not triggered 1004, the electronic correspondence is transmitted 1008 to the recipient. Merely by way of example, the electronic correspondence may be transmitted 1008 to the recipient via email.

The status of the email may be tracked 1010 as previously described. If the email was not opened 1012 after a predetermined time, an associated correspondence may be generated and mailed to the recipient 1014. The associated correspondence may include the primary information and decision-based components. The decision-based components may be different than the components included on the electronic correspondence. It should be appreciated that other criteria may also or additionally be used to trigger the generation and mailing of an associated correspondence.

In the foregoing description, for the purposes of illustration, methods were described in a particular order. It should be appreciated that in alternate embodiments, the methods may be performed in a different order than that described. Additionally, the methods may contain additional or fewer steps than described above. It should also be appreciated that the methods described above may be performed by hardware components or may be embodied in sequences of machine-executable instructions, which may be used to cause a machine, such as a general-purpose or special-purpose processor or logic circuits programmed with the instructions, to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A strategic communications system comprising:
a rules data store including a decision rule;
a recipient data store including recipient data for a plurality of recipients of a correspondence;
decision logic, communicatively coupled with the rules data store and the recipient data store, to determine for each of the recipients whether to include a decision-based component on the correspondence for the respective recipient based at least in part on the decision rule and the data associated with the respective recipient;
correspondence manager logic, communicatively coupled with the decision logic, to format the correspondence for each of the recipients; and
a printer, communicatively coupled with the correspondence manager logic, the printer including a selective perforation module to selectively add a perforation to the correspondences including the decision-based component.

2. The strategic communications system of claim 1, wherein the correspondences comprise a bill.

3. The strategic communications system of claim 1, wherein the decision-based component comprises a coupon.

4. The strategic communications system of claim 1, wherein the decision-based component comprises a check.

5. The strategic communications system of claim 1, wherein the printer further includes a MICR component to selectively add MICR information to the correspondences including the check.

6. The strategic communications system of claim 1 wherein the rules data store further includes a rule for inserting a color component and wherein the decision logic is further configured to determine for at least a subset of the correspondences whether to include the color component.

7. The strategic communications system of claim 6, wherein the printer further comprises at least one color module to selectively apply color to each of the correspondences including the color component.

8. The strategic communications system of claim 1, wherein the decision rule includes a condition for one of a recipient credit limit, a recipient account balance, and a recipient account type.

9. The strategic communications system of claim 1, wherein the decision rule includes a condition for a purchase of a product, the recipient data indicating recipients that purchased the product.

10. The strategic communications system of claim 1, wherein the correspondence manager logic is further configured to create and format electronic correspondences for a second subset of recipients.

11. The strategic communications system of claim 10, further comprising an electronic messaging system to deliver the electronic correspondences.

12. The strategic communications system of claim 11, wherein the electronic messaging system includes tracking data indicating whether one or more of the recipients in the second set opened the respective electronic correspondence.

13. The strategic communications system of claim 12, wherein the correspondence manager logic is further configured to after a predetermined time period, format an associated correspondence in physical format for at least one of the unopened electronic correspondences.

14. The strategic communications system of claim 10, wherein the correspondence logic is further configured to determine at least one of the electronic correspondences satisfies a mail criteria and based at least in part on the determination, to format a physical correspondence for the recipient of the determined electronic correspondence.

15. A method comprising:
obtaining, with a strategic communications system, a decision rule for a correspondence;
obtaining, with the strategic communications system, data associated with a recipient of the correspondence;
determining, with the strategic communications system, whether to include a decision-based component on the correspondence based at least in part on the decision rule and the data;
formatting, with the strategic communications system, the correspondence to include a selective perforation if the decision-based component is included; and
transmitting the correspondence to a printer, the printer configured to selectively add perforations to correspondences.

16. The method of claim 15, further comprising adding, with the printer, the selective perforation if the decision-based component is included.

17. The method of claim 15, wherein the decision-based component is included on the correspondence, the method further comprising formatting a correspondence for a second recipient, the correspondence for the second recipient not including the decision-based component.

18. The method of claim 15, wherein the correspondence includes a first page and a second page, the first page formatted to include the selective perforation and the second page formatted to not include the selective perforation.

19. The method of claim 15, wherein the correspondence comprises a bill.

20. The method of claim 15, wherein the decision-based component comprises one of a check and a coupon.

21. A method comprising:
obtaining, with a strategic communications system, a decision rule for a correspondence;
obtaining, with the strategic communications system, data associated with a recipient of the correspondence;
determining, with the strategic communications system, whether to include a decision-based component on the correspondence based at least in part on the decision rule and the data;
formatting, with the strategic communications system, the correspondence to include a selective color component if the decision-based component is included; and
transmitting the correspondence to a printer, the printer configured to selectively add color components to correspondences.

22. A method comprising:
creating, with a strategic communications system, an electronic correspondence for a recipient;
determining, with the strategic communications system, whether to include a decision-based component on the electronic correspondence based at least in part on a decision rule and data associated with the recipient;
formatting, with the strategic communications system, the electronic correspondence in accordance with the determination; and
transmitting the electronic correspondence to the recipient.

23. The method of claim 22, wherein the decision-based component comprises an offer including a hyperlink.

24. The method of claim 22, further comprising:
determining, with the strategic communications system, the electronic correspondence satisfies a mail criteria;
creating, with the strategic communications system, an associated correspondence in physical format for the recipient.

25. The method of claim 24, wherein creating the associated correspondence comprises adding at least one decision-based component not included in the electronic correspondence.

26. The method of claim 22, further comprising:
after a predetermined time, determining, with the strategic communications system, the recipient did not open the electronic correspondence; and
creating, with the strategic communications system, an associated correspondence in physical format for the recipient.
